(19) United States
(12) Patent Application Publication
(10) Pub. No.: US 2013/0291851 A1
(43) Pub. Date: Nov. 7, 2013

(54) CUTTING METHOD FOR CRACKLY PLATE-SHAPED WORK PIECE AND CUTTING DEVICE THEREOF

(71) Applicant: CHUN-SHENG CHIANG, YI-LAN HSIEN (TW)

(72) Inventor: CHUN-SHENG CHIANG, YI-LAN HSIEN (TW)

(21) Appl. No.: 13/852,464

(22) Filed: Mar. 28, 2013

(30) Foreign Application Priority Data
May 2, 2012 (TW) 101115577
Jul. 13, 2012 (TW) 101125227

(51) Int. Cl. B28D 1/32

(52) U.S. Cl. CPC B28D 1/327
USPC 125/23.01

(57) ABSTRACT

A cutting method for crackly plate-shaped work piece and a cutting device thereof. The cutting method includes steps of: using a holding mold set to hold two faces of the crackly plate-shaped work piece along a predetermined cutting line and hold a product section of the crackly plate-shaped work piece that is to remain; and making a cutting mold move toward the crackly plate-shaped work piece by a stroke or up and down bite and cut the crackly plate-shaped work piece so as to cut off the crackly plate-shaped work piece along an edge of the holding mold set in alignment with the predetermined cutting line.

### BACKGROUND OF THE INVENTION

1. Field of the Invention

The present invention relates generally to a cutting method for crackly plate-shaped work piece and a cutting device thereof. The cutting method includes steps of: using a holding mold set to hold two faces of the crackly plate-shaped work piece along a predetermined cutting line and hold a product section of the crackly plate-shaped work piece that is to remain; and making a cutting mold move toward the crackly plate-shaped work piece by a stroke or up and down bite and cut the crackly plate-shaped work piece so as to cut off the crackly plate-shaped work piece along an edge of the holding mold set in alignment with the predetermined cutting line.

2. Description of the Prior Art

In construction engineering, it is often seen that cut and surface-treated slates are adhered to the wall of a building to decorate the wall face or ground of the building. The slates are made from a natural raw stone by means of many-time cutting and surface treatment. Some of the slates are made from an artificial large-scale slate, which is cut into small slates with a necessary size.

During the current manufacturing process of the slates, the slates are generally processed by means of “sawing” such as water blade sawing, wire saw sawing and circular saw sawing or by means of milling with a miller or by means of grinding with a grinding wheel. In practice, the above processing methods have the following shortcomings:

1. The cutting travel is very long and the cutting process is slow so that it takes very much time to complete the cutting operation.

2. In cutting operation, a great amount of water is needed for cooling.

3. When milling, sawing or grinding the slate, a great amount of powder/dust is produced to cause serious environmental air pollution. This will threaten the health of the operators.

4. The cutting time is quite long so that the manufacturing cost is increased.

5. The slate is processed with the wire saw, the miller or the grinding wheel by a quite long processing profile, that is, a very long cutting travel. As a result, the wear of the blade is very great.

Recently, an “up-and-down bite slow cutting method” has been developed for biting/cutting two faces of the slate with a press. As shown in FIGS. 23 and 24, the biting/cutting mold set 50 includes a movable biting/cutting mold 50a and a fixed biting/cutting mold 50b, which are up and down aligned with each other. The movable biting/cutting mold 50a and the fixed biting/cutting mold 50b have a wedged cross section. The movable biting/cutting mold 50a is drivable by a biting/cutting drive mechanism 53 to move up and down toward or away from the fixed biting/cutting mold 50b. Each of the movable biting/cutting mold 50a and the fixed biting/cutting mold 50b has a biting/cutting edge 54 with a profile identical to that of a predetermined cutting line T of the slate 52.

The slate 52 is placed on the fixed biting/cutting mold 50b, while the movable biting/cutting mold 50a is drivable by the biting/cutting drive mechanism 53 for driving the movable biting/cutting mold 50a to slowly get close to the fixed biting/cutting mold 50b and the slate 52. The movable biting/cutting mold 50a and the fixed biting/cutting mold 50b are up and down aligned with each other to bite/cut upper and lower faces of the slate 52 so as to cut off the slate 52 along the tips of the movable biting/cutting mold 50a and the fixed biting/cutting mold 50b.

In practice, the above processing method has some shortcomings as follows:

1. In the “up-and-down bite slow cutting method”, when the movable biting/cutting mold 50a and the fixed biting/cutting mold 50b up and down bite/cut the slate 52, it is hard to form straight cut face. This is because the slate 52 is very hard and crackly. As a result, the cut face 52′ of the cut slate 52 often has a quite unsmooth profile. Moreover, it is hard to predict the shape of the slate 52 after cut. Therefore, the cut slate 52 often has an irregular saw-toothed profile.

2. The “up-and-down bite slow cutting method” is neither suitable for a thick slate nor a thin slate. In the case of a thick slate, it will be difficult to bite and cut off the slate. In the case of a too thin slate, the slate is likely to irregularly crack when cut.

3. The failure ratio in manufacturing of the slate is very high so that the “up-and-down bite slow cutting method” can be hardly popularized.

### SUMMARY OF THE INVENTION

It is therefore a primary object of the present invention to provide a cutting method for crackly plate-shaped work piece and a cutting device thereof. The cutting method for crackly plate-shaped work piece includes steps of: using a holding mold set including a movable holding mold and a fixed holding mold to hold two faces of a crackly plate-shaped work piece along a predetermined cutting line and hold a product section of the crackly plate-shaped work piece that is to remain; and making a cutting mold move toward the crackly plate-shaped work piece by a stroke to cut off the crackly plate-shaped work piece along an edge of the holding mold set in alignment with the predetermined cutting line.

In the above cutting method for crackly plate-shaped work piece, the crackly plate-shaped work piece is such as a natural slate or an artificial slate.

In the above cutting method for crackly plate-shaped work piece, the cutting mold serves to cut off the crackly plate-shaped work piece along the edge of the holding mold set to achieve a solid product of the crackly plate-shaped work piece. Alternatively, the holding mold set has inner hole and the cutting mold serves to cut off the crackly plate-shaped work piece along a periphery of the inner hole to achieve a product of the crackly plate-shaped work piece with an inner hole. Still alternatively, the holding mold set has inner hole and the cutting mold serves to cut off the crackly plate-shaped work piece along a periphery of the inner hole and the edge of the holding mold set to achieve a product of the crackly plate-shaped work piece with an inner hole and a preset profile.

In the above cutting method for crackly plate-shaped work piece, the predetermined cutting line is a closed line or an unclosed line. The edge or the periphery of the inner hole of the holding mold set corresponding to the predetermined cutting line is a closed line or an unclosed line with a profile identical to that of the closed line or unclosed line of the predetermined cutting line. Also, the edge of the cutting mold corresponding to the predetermined cutting line is a closed line or an unclosed line corresponding to the closed line or unclosed line of the edge or the periphery of the inner hole of the holding mold set. The shape of the predetermined cutting line is not limited.

In the above cutting method for crackly plate-shaped work piece, the holding mold set serves to hold two faces of the crackly plate-shaped work piece along the predetermined cutting line and hold a product section of the crackly plate-shaped work piece that is to remain. The cutting mold serves to cut off the crackly plate-shaped work piece along the holding edge of the holding mold set in alignment with the predetermined cutting line. The cutting method for the crackly plate-shaped work piece of the present invention is a method for holding two faces of the crackly plate-shaped work piece. This method is also applicable to the conventional “up-and-down bite slow cutting method” to improve the precision and smoothness of the cut profile of the crackly plate-shaped work piece. Therefore, the method for holding two faces of the crackly plate-shaped work piece provided by the present invention is a unique method as described hereinafter.

The above cutting method for crackly plate-shaped work piece is a method for holding a crackly plate-shaped work piece. A biting/cutting mold set serves to bite and cut two faces of the crackly plate-shaped work piece along the predetermined cutting line so as to bite and cut off the crackly plate-shaped work piece. The method is characterized in that the holding mold set to hold two faces of the crackly plate-shaped work piece along the predetermined cutting line. The holding mold set holds a product section of the crackly plate-shaped work piece that is to remain. The biting/cutting mold then moves toward the two faces of the crackly plate-shaped work piece to bite and cut the two faces of the crackly plate-shaped work piece along the edge of the holding mold set in alignment with the predetermined cutting line.

The cutting device for crackly plate-shaped work piece of the present invention includes a holding mold set and a cutting mold. The holding mold set includes a movable holding mold and a fixed holding mold. The fixed holding mold is fixed on a press. The movable holding mold is drivable by a holding drive mechanism, whereby the movable holding mold and the fixed holding mold can tightly hold two opposite sides of the crackly plate-shaped work piece. The holding mold set has a holding edge in alignment with the predetermined cutting line of the crackly plate-shaped work piece. The cutting mold is drivable by a cutting drive mechanism. The cutting mold has a cutting edge with a profile identical to that of the holding edge. The cutting edge and the corresponding holding edge are positioned on the same plane in parallel to the driving direction of the cutting drive mechanism. The cutting drive mechanism serves to drive the cutting mold to move by a travel so as to cut off the crackly plate-shaped work piece held by the movable holding mold and the fixed holding mold. After the holding mold set releases the crackly plate-shaped work piece, a product of the crackly plate-shaped work piece is achieved.

In the above cutting device for the crackly plate-shaped work piece, the holding edges of the movable holding mold and the fixed holding mold can have the form of a straight line or a curve. The cutting edge of the cutting mold has a profile identical to that of the holding edge of the holding mold set.

In the above cutting device for the crackly plate-shaped work piece, the holding edge of the holding mold set is positioned along an outer periphery of the holding mold set and has the form of an unclosed line such as a straight line or a curve or a closed polygon. The cutting edge of the cutting mold has a profile identical to that of the holding edge of the holding mold set.

In the above cutting device for the crackly plate-shaped work piece, the holding edge of the holding mold set is positioned inside the holding mold set and has the form of a closed polygon. The cutting edge of the cutting mold has a profile identical to that of the holding edge of the holding mold set.

In the above cutting device for the crackly plate-shaped work piece, the holding mold set serves to hold two faces of the crackly plate-shaped work piece along the predetermined cutting line and hold a product section of the crackly plate-shaped work piece that is to remain. The cutting mold serves to cut off the crackly plate-shaped work piece along the edge of the holding mold set in alignment with the predetermined cutting line. The cutting device for the crackly plate-shaped work piece of the present invention is a device for holding two faces of the crackly plate-shaped work piece. This device is also applicable to the conventional “up-and-down bite slow cutting method” to improve the precision and smoothness of the cut profile of the crackly plate-shaped work piece. Therefore, the device for holding two faces of the crackly plate-shaped work piece provided by the present invention is also a unique device as described hereinafter.

The cutting device for the crackly plate-shaped work piece of the present invention is used in the above cutting method for the crackly plate-shaped work piece. The cutting device includes a biting/ cutting mold set serving to bite and cut two faces of the crackly plate-shaped work piece along the predetermined cutting line so as to cut off the crackly plate-shaped work piece. The cutting device is characterized in that the cutting device further includes a holding mold set having a movable holding mold and a fixed holding mold. The fixed holding mold is fixed on a press. The movable holding mold is drivable by a holding drive mechanism, whereby the movable holding mold and the fixed holding mold can tightly hold two opposite sides of the crackly plate-shaped work piece and hold a product section of the crackly plate-shaped work piece that is to remain. The biting/cutting mold is then moved toward the two faces of the crackly plate-shaped work piece to bite and cut the two faces of the crackly plate-shaped work piece along the edge of the holding mold set in alignment with the predetermined cutting line.

In the above cutting method and cutting device for the crackly plate-shaped work piece of the present invention, the preserved product section of the crackly plate-shaped work piece is tightly held between the movable holding mold and the fixed holding mold. In the instant of cutting the crackly plate-shaped work piece with the cutting mold, the maximum shear force is produced at the intersection of the cutting mold and the movable holding mold and the fixed holding mold. Therefore, the crackly plate-shaped work piece can be successfully cut off along the intersection of the cutting mold and the movable holding mold and the fixed holding mold without cracking the product section of the crackly plate-shaped work piece, which is held between the movable holding mold and the fixed holding mold. This has been proved by the applicant in many-time tests.

In the above cutting method and cutting device for the crackly plate-shaped work piece of the present invention, an elastic pad layer is adhered to each of the holding faces of the movable holding mold and the fixed holding mold. Accordingly, in the case that the movable holding mold and the fixed holding mold are used to hold a crackly plate-shaped work piece with unsmooth surfaces, the movable holding mold and the fixed holding mold can still tightly attach to the surfaces of the crackly plate-shaped work piece.

In the cutting method and cutting device for the crackly plate-shaped work piece of the present invention, at least one support mold is further disposed under the waste material section of the crackly plate-shaped work piece to stably support the crackly plate-shaped work piece. During the cutting process, the support mold serves to prevent the crackly plate-shaped work piece held between the movable holding mold and the fixed holding mold from cracking due to excessively great bending stress.

In the cutting method and cutting device for the crackly plate-shaped work piece of the present invention, multiple movable holding molds and multiple fixed holding molds are used to tightly hold two faces of the crackly plate-shaped work piece. Two cutting gaps are formed between each two adjacent holding mold sets on two faces of the crackly plate-shaped work piece. The cutting gaps on two faces of the crackly plate-shaped work piece are aligned with each other. Multiple cutting molds are aimed at the cutting gaps. Accordingly, at one time of downward stroke, the multiple cutting molds can more precisely cut and process the crackly plate-shaped work piece at many sections along the predetermined cutting lines.

In the above cutting method and cutting device for the crackly plate-shaped work piece of the present invention, a press can be used to fast press and cut the work piece or a slow-speed hydraulic/pneumatic cylinder can be used to press and cut one single side of the work piece. This is not limited. However, the hydraulic/pneumatic cutting method of the present invention only includes the single-side slow-speed pressing/cutting, while excluding two-side biting/cutting. (This is because the two-side biting/cutting pertains to prior art).

In the above cutting method for the crackly plate-shaped work piece of the present invention, no conventional water blade or miller is used for cutting the work piece. Instead, the work piece is held between the movable holding mold and the fixed holding mold to be cut off by the cutting mold. Therefore, the present invention has the following advantages:

1. The crackly plate-shaped work piece can be quickly cut to greatly shorten the working time and lower the manufacturing cost.

2. During the cutting process, the amount of the produced powder/dust is greatly reduced so that the air pollution problem is solved.

3. It is unnecessary to use any cooling water so that the water resource is saved and the water pollution is reduced.

4. The total cost for the cutting is extremely low so that the manufacturing cost is greatly lowered.

The present invention can be best understood through the following description and accompanying drawings, wherein:

### BRIEF DESCRIPTION OF THE DRAWINGS

FIG. 1 is a perspective view showing a crackly plate-shaped work piece before cut by means of the present invention;

FIG. 2 is a view showing that the crackly plate-shaped work piece is held by the holding mold set of the present invention;

FIG. 3 is a view according to FIG. 2, showing that the crackly plate-shaped work piece is cut by the cutting mold of the present invention;

FIG. 4 is a perspective view showing the product of the crackly plate-shaped work piece of FIG. 3 after cut by means of the present invention;

FIG. 5 is a perspective view showing a crackly plate-shaped work piece to be cut with an inner hole by means of the present invention;

FIG. 6 is a view showing that the crackly plate-shaped work piece of FIG. 5 is held by the holding mold set of the present invention but not yet cut by the cutting mold;

FIG. 7 is a view according to FIG. 6, showing that the crackly plate-shaped work piece is cut by the cutting mold of the present invention;

FIG. 8 is a perspective view showing the product of the crackly plate-shaped work piece of FIG. 7 after cut by means of the present invention;

FIG. 9 is a perspective view showing a crackly plate-shaped work piece to be cut with both an inner hole and an outer profile by means of the present invention;

FIG. 10 is a view showing that the crackly plate-shaped work piece of FIG. 9 is held by the holding mold set of the present invention but not yet cut by the cutting mold;

FIG. 11 is a view according to FIG. 10, showing that the crackly plate-shaped work piece is cut by the cutting mold of the present invention;

FIG. 12 is a perspective view showing the product of the crackly plate-shaped work piece of FIG. 11 after cut by means of the present invention;

FIG. 13 is a view showing that the crackly plate-shaped work piece is tightly held between the elastic pad layers of the holding mold set of the present invention and cut by the cutting mold;

FIG. 14 is a view of another embodiment of the present invention, showing that the crackly plate-shaped work piece is held by the holding mold set of the present invention but not yet cut by the cutting mold;

FIG. 15 is a view showing that the crackly plate-shaped work piece is held by multiple holding mold sets and cut by multiple cutting molds at many sections;

FIG. 16 is a perspective view of the cutting device for the crackly plate-shaped work piece of the present invention;

FIG. 17 is a view showing that a crackly plate-shaped work piece is tightly held by the holding mold set of the present invention;

FIG. 18 is a view showing that the crackly plate-shaped work piece is cut by the cutting mold of the present invention;

FIG. 19 is a view showing that the crackly plate-shaped work piece is released by the holding mold set after cut;

FIG. 20 is a perspective view showing that the holding mold set of the present invention is applied to a conventional up-and-down bite slow cutting method and device;

FIG. 21 is a front view showing that the holding mold set of FIG. 16 is mounted on a press;

FIG. 22 is a front view showing that the holding mold set of FIG. 20 is mounted on a press;

FIG. 23 is a perspective view showing the conventional up-and-down bite slow cutting method and the device thereof; and

FIG. 24 is a view showing the operation of the conventional up-and-down bite slow cutting device.

### DETAILED DESCRIPTION OF THE PREFERRED EMBODIMENTS

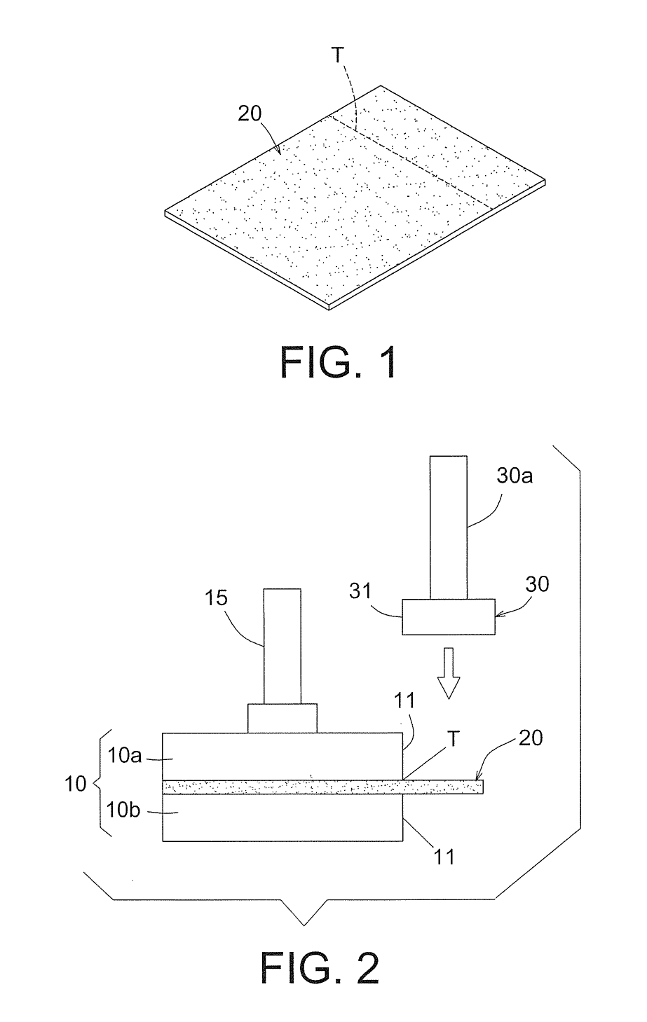

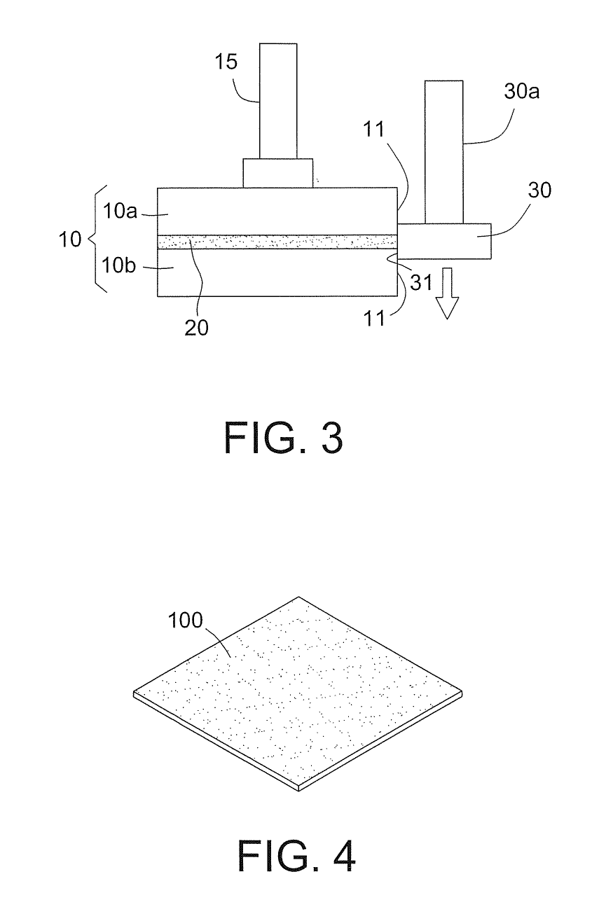

Please refer to FIGS. 1 to 4. The cutting method for crackly plate-shaped work piece of the present invention includes steps of: using a holding mold set 10 to hold two faces of a crackly plate-shaped work piece 20 along a predetermined cutting line T, the holding mold set 10 including a movable holding mold 10a and a fixed holding mold 10b, the holding mold set 10 holding a product section of the crackly plate-shaped work piece 20 that is to remain; and making a cutting mold 30 move toward the crackly plate-shaped work piece 20 by a stroke to cut off the crackly plate-shaped work piece 20 along a holding edge 11 of the movable holding mold 10a and the fixed holding mold 10b in alignment with the predetermined cutting line T.

The crackly plate-shaped work piece 20 is such as a natural slate or an artificial slate.

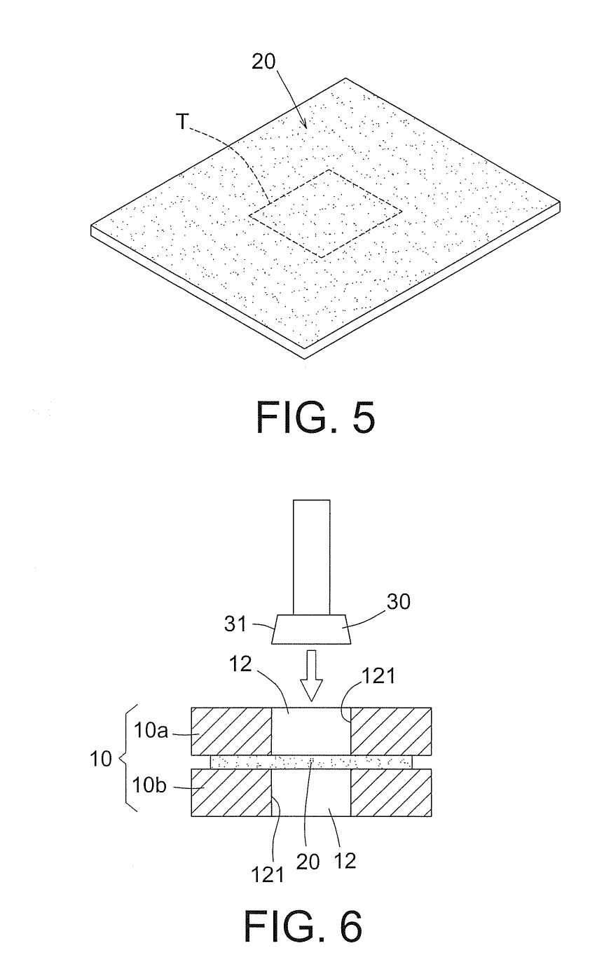

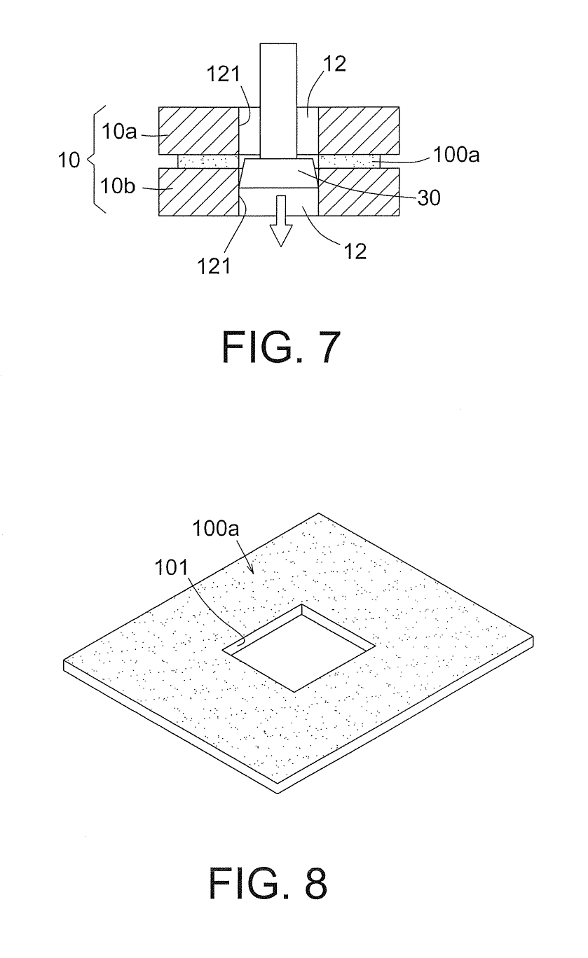

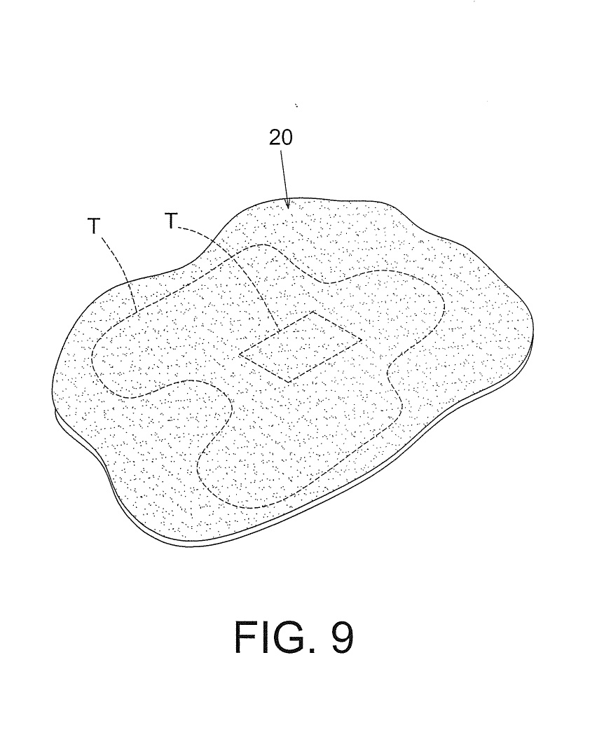

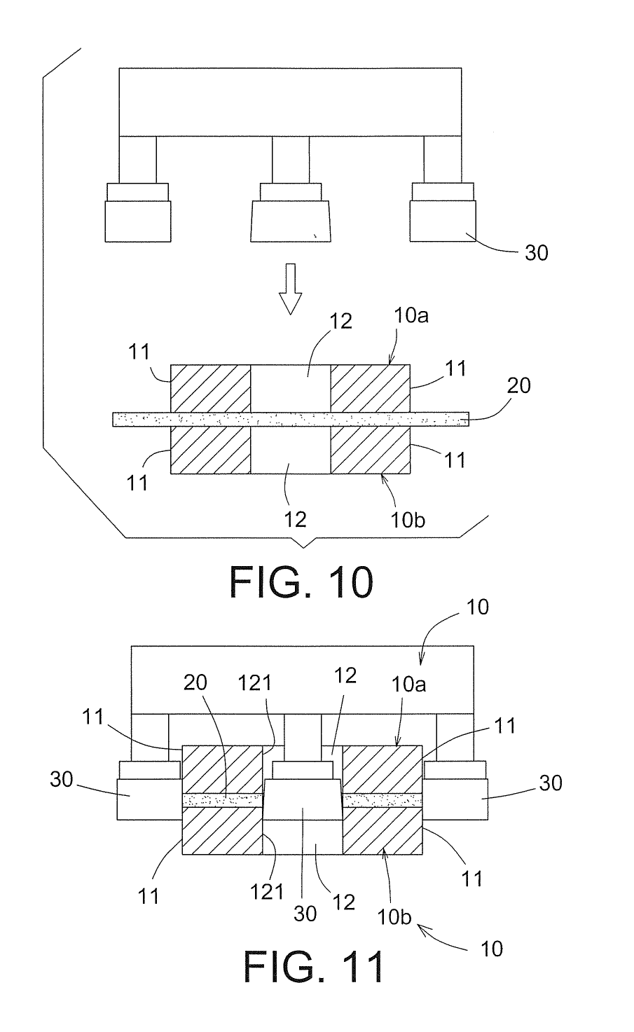

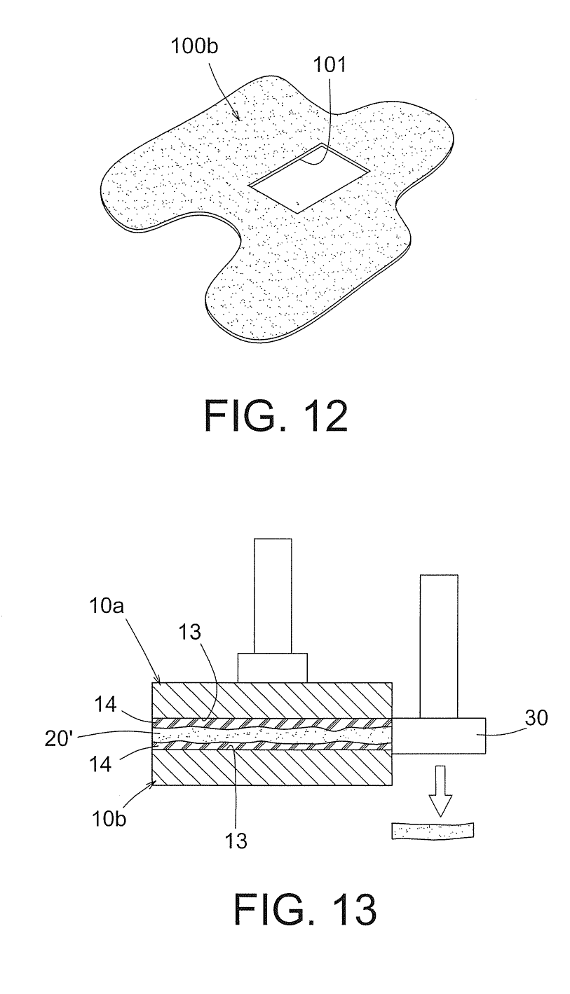

Please refer to FIGS. 1 to 4. In the cutting method for crackly plate-shaped work piece of the present invention, the cutting mold 30 serves to cut off the crackly plate-shaped work piece 20 along the holding edge 11 of the movable holding mold 10a and the fixed holding mold 10b of the holding mold set 10 to achieve a solid product 100 of the crackly plate-shaped work piece 20. Alternatively, as shown in FIGS. 5 to 8, the holding mold set 10 has at least one inner hole 12 and the cutting mold 30 serves to cut off the crackly plate-shaped work piece 20 along a periphery 121 of the inner hole 12 to achieve a product 100a of the crackly plate-shaped work piece 20 with an inner hole 101. Still alternatively, as shown in FIGS. 9 to 12, the holding mold set 10 has the inner hole 12 and the cutting mold 30 serves to cut off the crackly plate-shaped work piece 20 along the periphery 121 of the inner hole 12 and the holding edge 11 of the holding mold set 10 to achieve a product 100b of the crackly plate-shaped work piece 20 with an inner hole 101 and a preset profile.

In the cutting method for crackly plate-shaped work piece of the present invention, the predetermined cutting line T can be a closed line or an unclosed line. The unclosed line is such as a straight line (as shown in FIG. 1), a curve (not shown) or a bending line (not shown). The closed line is such as a geometric closed curve (as shown in FIG. 5), a closed curve with any shape (as shown in FIG. 9) or a complex closed curve of a straight line and a curve with any shape (not shown). That is, the holding edge 11 or the periphery 121 of the inner hole of the holding mold set 10 corresponding to the predetermined cutting line T is a closed line or an unclosed line. Also, the cutting edge 31 of the cutting mold 30 corresponding to the predetermined cutting line T is a closed line or an unclosed line corresponding to the closed line or unclosed line of the holding edge 11 or the periphery 121 of the inner hole of the holding mold set 10. The shape of the predetermined cutting line T is not limited.

In the cutting method for crackly plate-shaped work piece of the present invention, the holding mold set 10 serves to hold two faces of the crackly plate-shaped work piece 20 along the predetermined cutting line T, that is, hold a product section of the crackly plate-shaped work piece 20 that is to remain. The cutting mold 30 serves to cut off the crackly plate-shaped work piece 20 along the holding edge 11 of the holding mold set 10 in alignment with the predetermined cutting line T. The cutting method for the crackly plate-shaped work piece of the present invention is a method for holding two faces of the crackly plate-shaped work piece 20. This method is also applicable to the conventional “up-and-down bite slow cutting method” to improve the precision and smoothness of the cut profile of the crackly plate-shaped work piece 20. Therefore, the method for holding two faces of the crackly plate-shaped work piece 20 provided by the present invention is a unique method as described hereinafter.

The cutting method for crackly plate-shaped work piece of the present invention is a method for holding a crackly plate-shaped work piece. A biting/cutting mold set 50 serves to bite and cut two faces of the crackly plate-shaped work piece 20 along the predetermined cutting line T so as to bite and cut off the crackly plate-shaped work piece 20. The method is characterized in that the holding mold set 10 to hold two faces of the crackly plate-shaped work piece 20 along the predetermined cutting line T. The holding mold set 50 holds a product section of the crackly plate-shaped work piece 20 that is to remain. The biting/ cutting mold 50 then moves toward the two faces of the crackly plate-shaped work piece 20 to bite and cut the two faces of the crackly plate-shaped work piece 20 along the edge of the holding mold set 10 in alignment with the predetermined cutting line T.

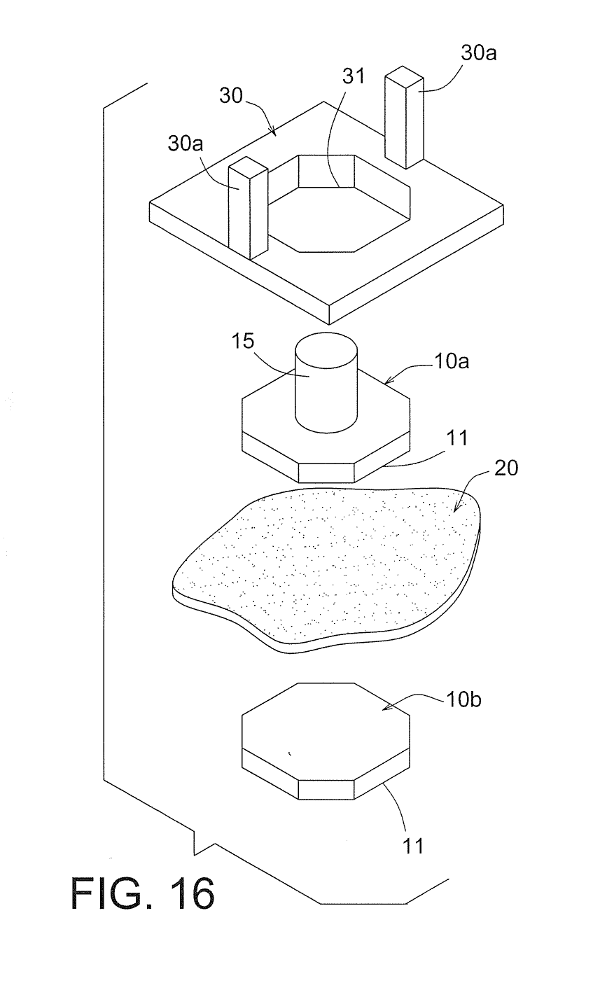

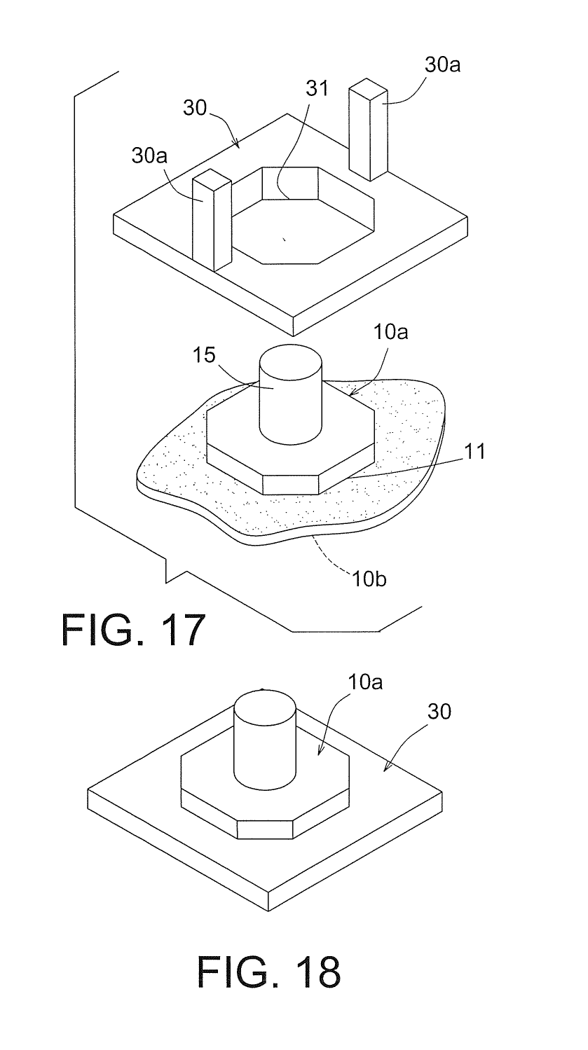

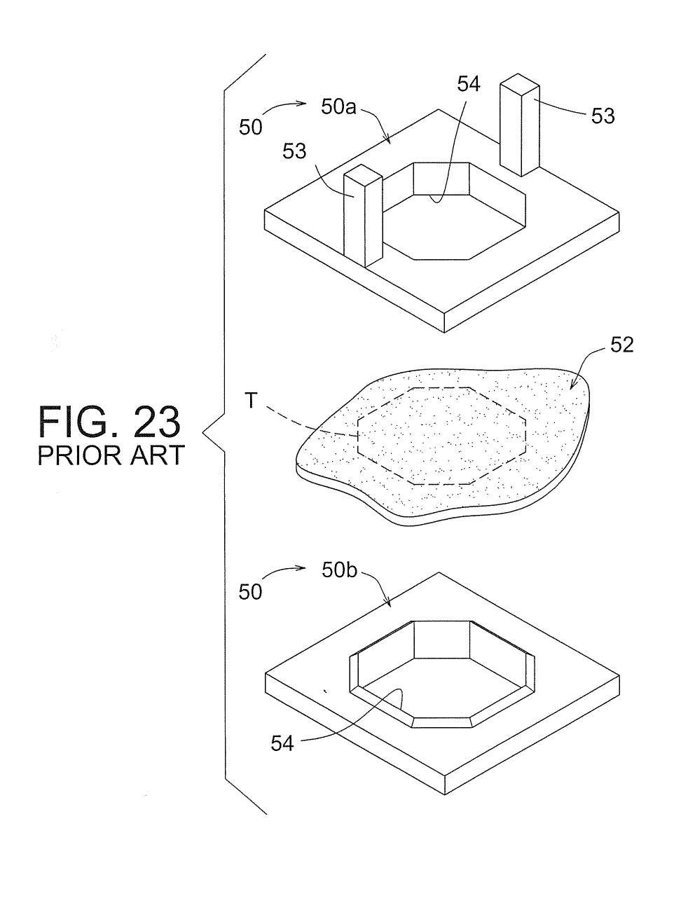

Please refer to FIGS. 16 and 23. The cutting device for crackly plate-shaped work piece of the present invention includes a holding mold set 10 and a cutting mold 30. The holding mold set 10 includes a movable holding mold 10a and a fixed holding mold 10b. The fixed holding mold 10b is fixed on a press. The movable holding mold 10a is drivable by a holding drive mechanism 15, whereby the movable holding mold 10a and the fixed holding mold 10b can tightly hold two opposite sides of the crackly plate-shaped work piece 20. As shown in FIGS. 2 and 17, the holding mold set 10 has a holding edge 11 in alignment with the predetermined cutting line T of the crackly plate-shaped work piece 20.

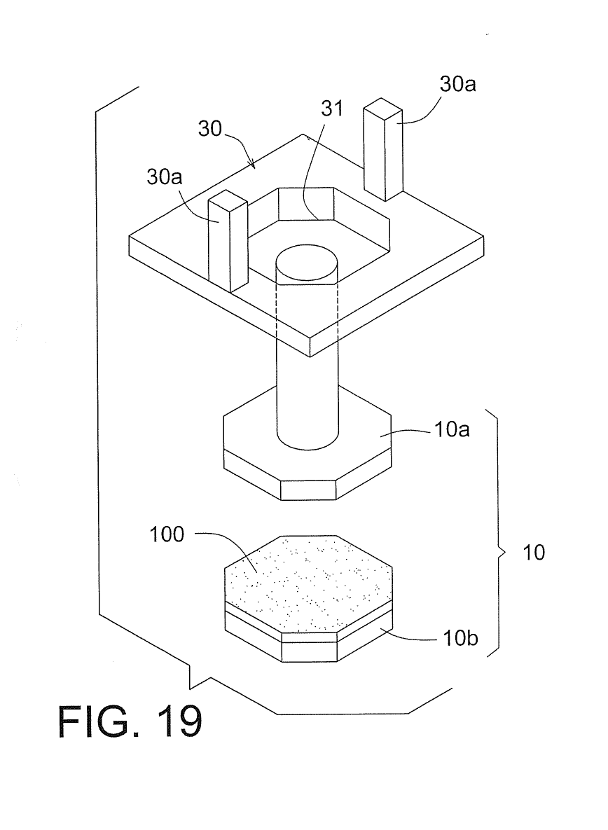

The cutting mold 30 is drivable by a cutting drive mechanism 30a. The cutting mold 30 has a cutting edge 31 with a profile identical to that of the holding edge 11. The cutting edge 31 and the corresponding holding edge 11 are positioned on the same plane in parallel to the driving direction of the cutting drive mechanism 30a. The cutting drive mechanism 30a serves to drive the cutting mold 30 to move by a travel so as to cut off the crackly plate-shaped work piece 20 held by the movable holding mold 10a and the fixed holding mold 10b as shown in FIG. 18. After the movable holding mold 10a and the fixed holding mold 10b release the crackly plate-shaped work piece 20, a product 100 of the crackly plate-shaped work piece 20 is achieved (as shown in FIG. 19).

In the above cutting device for the crackly plate-shaped work piece, the holding edge 11 of the holding mold set 10 can have the form of a straight line or a curve. The cutting edge 31 of the cutting mold 30 has a shape identical to that of the holding edge 11 of the holding mold set 10.

In the cutting device for the crackly plate-shaped work piece of the present invention, the holding edge 11 of the holding mold set 10 is positioned along an outer periphery of the movable holding mold 10a and the fixed holding mold 10b and has the form of an unclosed line such as a straight line or a curve or a closed polygon. The cutting edge 31 of the cutting mold 30 has a profile identical to that of the holding edge 11 of the holding mold set 10.

In the cutting device for the crackly plate-shaped work piece of the present invention, the holding edge 11 of the holding mold set 10 is positioned inside the holding mold set 10 and has the form of a closed polygon. The cutting edge 31 of the cutting mold 30 has a profile identical to that of the holding edge 11 of the holding mold set 10.

The movable holding mold 10a and the fixed holding mold 10b can be driven by a hydraulic mechanical structure, a pneumatic mechanical structure or any other suitable mechanical structure to press and hold the work piece. This is not limited.

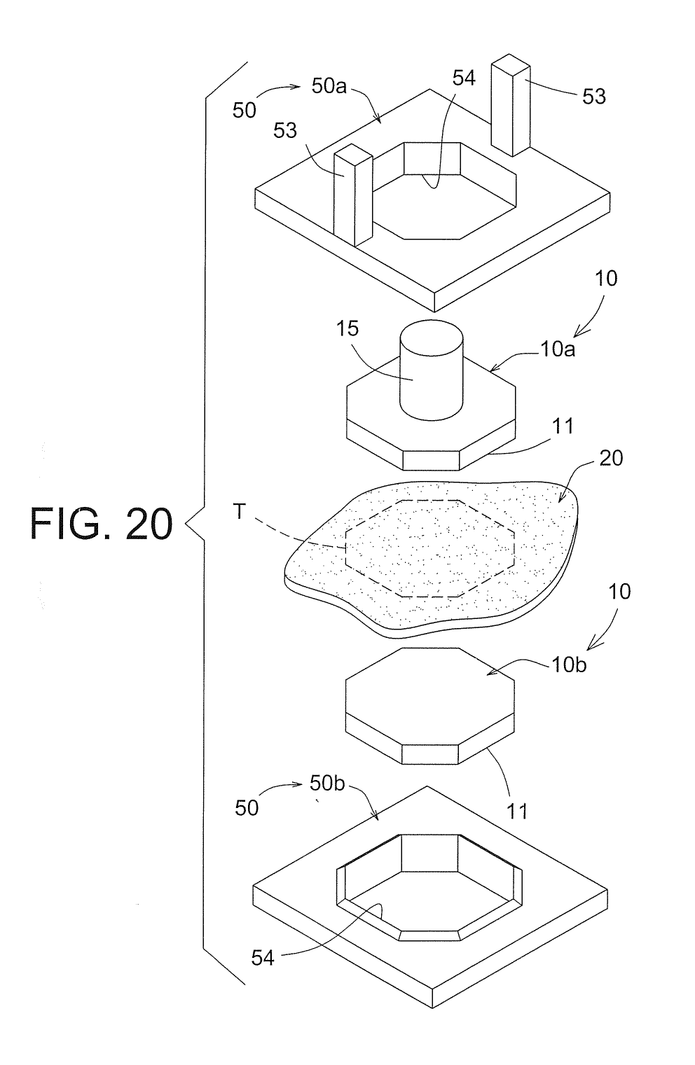

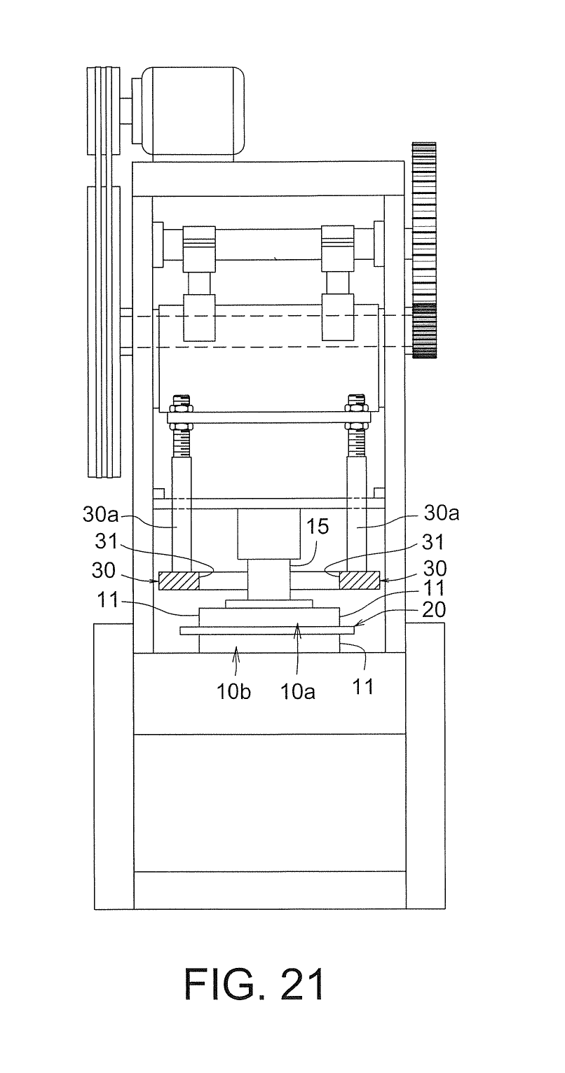

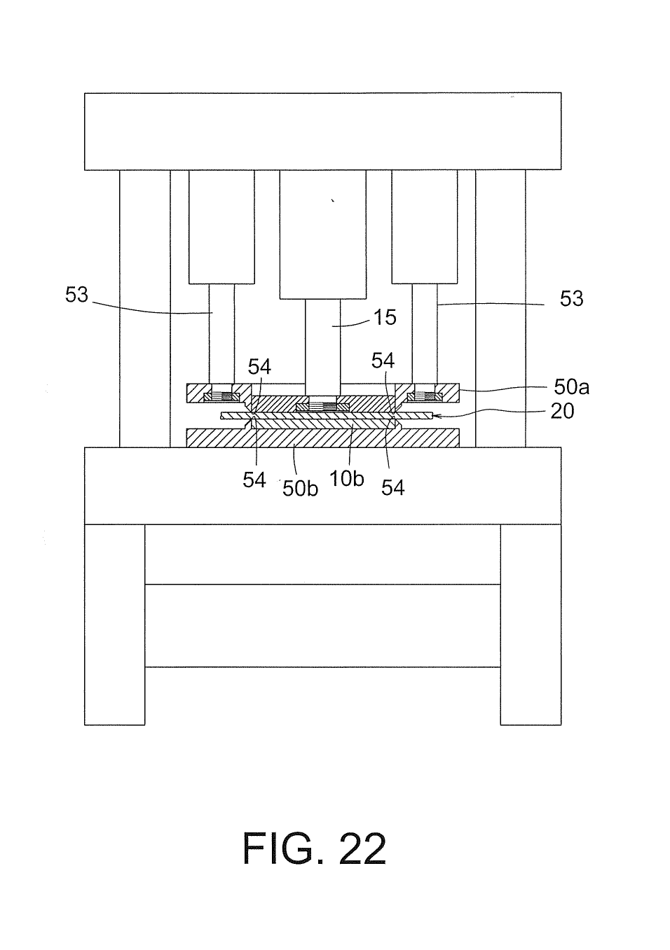

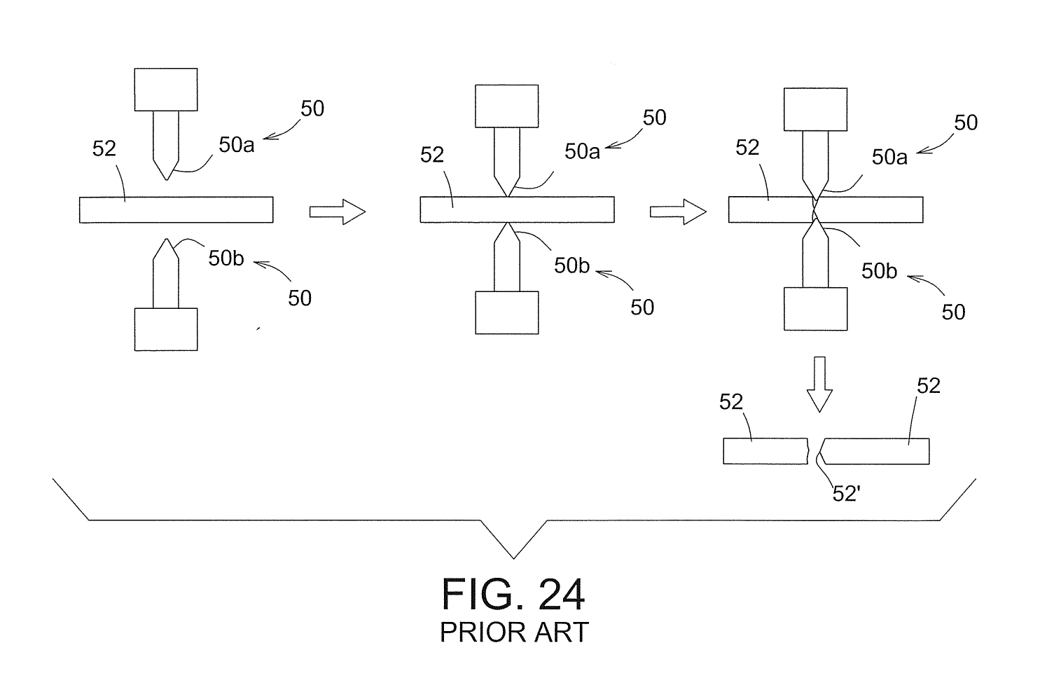

As shown in FIGS. 20 and 24, in the cutting device for the crackly plate-shaped work piece of the present invention, the holding mold set 10 serves to hold two faces of the crackly plate-shaped work piece 20 along the predetermined cutting line T, that is, hold a product section of the crackly plate-shaped work piece 20 that is to remain. The cutting mold 30 serves to cut off the crackly plate-shaped work piece 20 along the edge of the holding mold set 10 in alignment with the predetermined cutting line T. The cutting device for the crackly plate-shaped work piece of the present invention is a device for holding two faces of the crackly plate-shaped work piece 20. This device is also applicable to the conventional “up-and-down bite slow cutting method” to improve the precision and smoothness of the cut profile of the crackly plate-shaped work piece 20. Therefore, the device for holding two faces of the crackly plate-shaped work piece 20 provided by the present invention is also a unique device as described hereinafter.

As shown in FIGS. 20 and 24, the cutting device for the crackly plate-shaped work piece of the present invention is used in the above cutting method for the crackly plate-shaped work piece. The cutting device includes a biting/cutting mold set 50 serving to bite and cut two faces of the crackly plate-shaped work piece 20 along the predetermined cutting line T so as to cut off the crackly plate-shaped work piece 20. The cutting device is characterized in that the cutting device further includes a holding mold set 10 having a movable holding mold 10a and a fixed holding mold 10b. The fixed holding mold 10b is fixed on a press (not shown). The movable holding mold 10a is drivable by a holding drive mechanism 15, whereby the movable holding mold 10a and the fixed holding mold 10b can tightly hold two opposite sides of the crackly plate-shaped work piece 20 and hold a product section of the crackly plate-shaped work piece 20 that is to remain. The biting/cutting mold 50 is then moved toward the two faces of the crackly plate-shaped work piece 20 to bite and cut the two faces of the crackly plate-shaped work piece 20 along the edge of the holding mold set 10 in alignment with the predetermined cutting line T.

The cutting drive mechanism 30a can be formed of a crank slide block mechanism, which is directly driven by a motor, (that is, the four-bar linkage of a stamping press). Alternatively, the cutting drive mechanism 30a can be driven by a pneumatic cylinder or a hydraulic cylinder.

The biting/cutting drive mechanism 53 for driving the movable biting/cutting mold 50a and the holding drive mechanism 15 can be driven by a pneumatic cylinder or a hydraulic cylinder.

In the cutting method and cutting device for the crackly plate-shaped work piece of the present invention, a press can be used to fast press and cut the work piece or a slow-speed hydraulic/pneumatic cylinder can be used to press and cut one single side of the work piece. This is not limited. However, the hydraulic/pneumatic cutting method of the present invention only includes the single-side slow-speed pressing/cutting, while excluding two-side biting/cutting. (This is because the two-side biting/cutting pertains to prior art).

In the cutting method and cutting device for the crackly plate-shaped work piece of the present invention, the preserved product section of the crackly plate-shaped work piece 20 is tightly held between the movable holding mold 10a and the fixed holding mold 10b. In the instant of cutting the crackly plate-shaped work piece 20 with the cutting mold 30, the maximum shear force is produced at the intersection of the cutting mold 30 and the movable holding mold 10a and the fixed holding mold 10b. Therefore, the crackly plate-shaped work piece 20 can be successfully cut off along the intersection of the cutting mold 30 and the movable holding mold 10a and the fixed holding mold 10b without cracking the product section of the crackly plate-shaped work piece 20, which is held between the movable holding mold 10a and the fixed holding mold 10b. This has been proved by the applicant in many-time tests.

As shown in FIG. 13, in the cutting method and cutting device for the crackly plate-shaped work piece of the present invention, an elastic pad layer 14 is adhered to each of the holding faces 13 of the movable holding mold 10a and the fixed holding mold 10b. Accordingly, in the case that the movable holding mold 10a and the fixed holding mold 10b are used to hold a crackly plate-shaped work piece 20′ with unsmooth surfaces, the movable holding mold 10a and the fixed holding mold 10b can still tightly attach to the surfaces of the crackly plate-shaped work piece 20′.

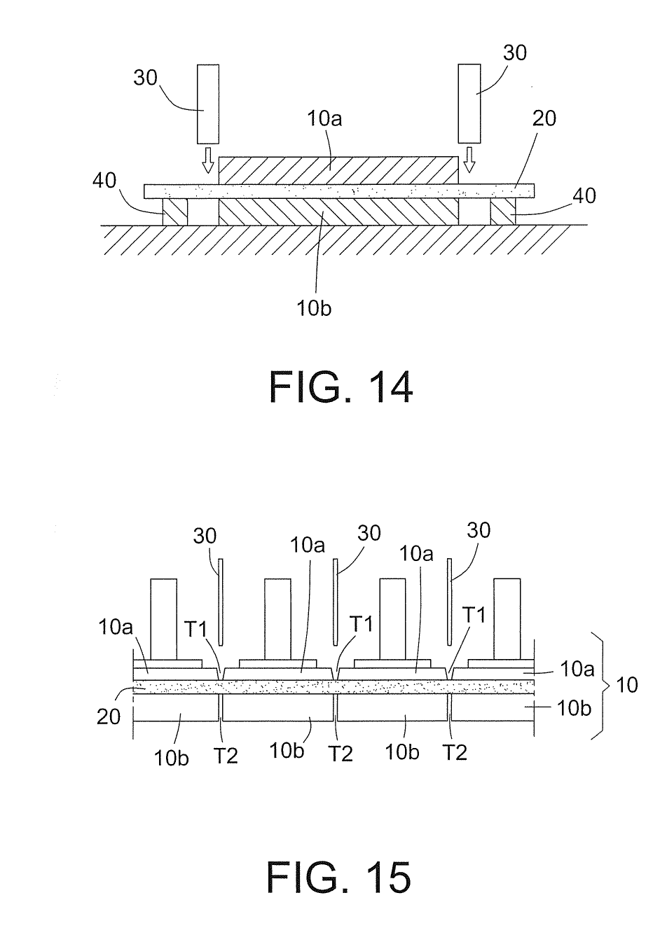

Referring to FIG. 14, in the cutting method and cutting device for the crackly plate-shaped work piece of the present invention, at least one support mold 40 is further disposed under the waste material section of the crackly plate-shaped work piece 20 to stably support the crackly plate-shaped work piece 20. During the cutting process, the support mold 40 serves to prevent the crackly plate-shaped work piece 20 held between the movable holding mold 10a and the fixed holding mold 10b from cracking due to excessively great bending stress.

Referring to FIG. 15, multiple movable holding molds 10a and multiple fixed holding molds 10b can be used to tightly hold two faces of the crackly plate-shaped work piece 20. Two cutting gaps T1, T2 are formed between each two adjacent holding mold sets 10 on two faces of the crackly plate-shaped work piece 20. The cutting gaps T1, T2 on two faces of the crackly plate-shaped work piece 20 are aligned with each other. Multiple cutting molds 30 are aimed at the cutting gaps T1. Accordingly, at one time of downward stroke, the multiple cutting molds 30 can more precisely cut and process the crackly plate-shaped work piece 20 at many sections along the predetermined cutting lines.

In the cutting method for the crackly plate-shaped work piece of the present invention, no conventional water blade or miller is used for cutting the work piece. Instead, the work piece is held between the movable holding mold 10a and the fixed holding mold 10b to be cut off by the cutting mold 30. Therefore, the present invention has the following advantages:

1. The crackly plate-shaped work piece can be precisely cut and processed to achieve a product of the crackly plate-shaped work piece with a desired shape or profile.

2. The crackly plate-shaped work piece can be quickly cut to greatly shorten the working time and lower the manufacturing cost.

3. During the cutting process, the amount of the produced powder/dust is greatly reduced so that the air, pollution problem is solved.

4. It is unnecessary to use any cooling water so that the water resource is saved and the water pollution is reduced.

5. The attrition rate of the manufacturing tools is extremely low so that the cost for the tools is lowered.

6. The total cost for the cutting is extremely low so that the manufacturing cost is greatly lowered.

In the cutting method and cutting device for the crackly plate-shaped work piece of the present invention, the cutting/processing method and device are innovatively combined with the holding method and device to overcome the long since problem that the crackly plate-shaped work piece such as a slate cannot be processed by cutting. The present invention changes the concept that the crackly plate-shaped work piece such as a slate must be processed by sawing (water blade sawing, wire saw sawing and circular saw sawing) or grinding wheel grinding.

The above embodiments are only used to illustrate the present invention, not intended to limit the scope thereof. Many modifications of the above embodiments can be made without departing from the spirit of the present invention.

What is claimed is:

1. A cutting method for crackly plate-shaped work piece, comprising steps of: using a holding mold set to hold two faces of a crackly plate-shaped work piece along a predetermined cutting line and hold a product section of the crackly plate-shaped work piece that is to remain; and making a cutting mold move toward the crackly plate-shaped work piece by a stroke to cut off the crackly plate-shaped work piece along an edge of the holding mold set in alignment with the predetermined cutting line.

2. The cutting method for crackly plate-shaped work piece as claimed in claim 1, wherein the cutting mold serves to cut off the crackly plate-shaped work piece along an edge of the holding mold set to achieve a solid product of the crackly plate-shaped work piece.

3. The cutting method for crackly plate-shaped work piece as claimed in claim 1, wherein the holding mold set has inner hole and the cutting mold serves to cut off the crackly plate-shaped work piece along a periphery of the inner hole to achieve a product of the crackly plate-shaped work piece with an inner hole.

4. The cutting method for crackly plate-shaped work piece as claimed in claim 1, wherein the holding mold set has inner hole and the cutting mold serves to cut off the crackly plate-shaped work piece along a periphery of the inner hole and an edge of the holding mold set to achieve a product of the crackly plate-shaped work piece with an inner hole and a preset profile.

5. The cutting method for crackly plate-shaped work piece as claimed in claim 1, wherein the edge of the holding mold set for holding two faces of the crackly plate-shaped work piece corresponding to the predetermined cutting line is a closed line or an unclosed line, the edge of the cutting mold corresponding to the predetermined cutting line being a closed line or an unclosed line with a form identical to that of the closed line or unclosed line of the edge of the holding mold set.

6. The cutting method for crackly plate-shaped work piece as claimed in claim 1, wherein an elastic pad layer is adhered to each holding face of the holding mold set, whereby in the case that the holding mold set is used to hold a crackly plate-shaped work piece with unsmooth surfaces, the holding mold set can still tightly attach to the surfaces of the crackly plate-shaped work piece.

7. The cutting method for crackly plate-shaped work piece as claimed in claim 1, further comprising at least one support mold disposed under a waste material section of the crackly plate-shaped work piece to support the crackly plate-shaped work piece.

8. The cutting method for crackly plate-shaped work piece as claimed in claim 1, wherein multiple holding mold sets are used to tightly hold two faces of the crackly plate-shaped work piece, two cutting gaps being formed between each two adjacent holding mold sets on two faces of the crackly plate-shaped work piece, the cutting gaps on two faces of the crackly plate-shaped work piece being aligned with each other, multiple cutting molds being respectively aimed at the cutting gaps, whereby at one time of downward stroke, the multiple cutting molds can cut and process the crackly plate-shaped work piece at many sections.

9. A cutting device for crackly plate-shaped work piece, which is used in the cutting method for crackly plate-shaped work piece as claimed in claim 1, the cutting device comprising a holding mold set and a cutting mold, the holding mold set including a movable holding mold and a fixed holding mold, the fixed holding mold being fixed on a press, the movable holding mold being drivable by a holding drive mechanism, whereby the movable holding mold and the fixed holding mold can tightly hold two opposite sides of the crackly plate-shaped work piece, the movable holding mold and the fixed holding mold having holding edges in alignment with the predetermined cutting line of the crackly plate-shaped work piece, the cutting mold being drivable by a cutting drive mechanism, the cutting mold having a cutting edge with a profile identical to that of the holding edge, the cutting edge and the corresponding holding edge being positioned on the same plane in parallel to a driving direction of the cutting drive mechanism, the cutting drive mechanism serving to drive the cutting mold to move by a travel so as to cut off the crackly plate-shaped work piece held by the holding mold set.

10. The cutting device for crackly plate-shaped work piece as claimed in claim 9, wherein the holding edge of the holding mold set is in the form of a straight line or a curve.

11. The cutting device for crackly plate-shaped work piece as claimed in claim 9, wherein the holding edge of the holding mold set is positioned along an outer periphery of the holding mold set and has the form of an unclosed line or a closed polygon.

12. The cutting device for crackly plate-shaped work piece as claimed in claim 9, wherein the holding edge of the holding mold set is positioned inside the holding mold set and has the form of a closed polygon.

13. The cutting device for crackly plate-shaped work piece as claimed in claim 9, wherein an elastic pad layer is adhered to each of the holding faces of the movable holding mold and the fixed holding mold.

14. The cutting device for crackly plate-shaped work piece as claimed in claim 9, further comprising at least one support mold disposed under a waste material section of the crackly plate-shaped work piece to support the crackly plate-shaped work piece.

15. A holding method for crackly plate-shaped work piece, a cutting mold being moved toward the crackly plate-shaped work piece to cut off the crackly plate-shaped work piece along a predetermined cutting line, the holding method being characterized in that a holding mold set is used to hold two faces of the crackly plate-shaped work piece along the predetermined cutting line and hold a product section of the crackly plate-shaped work piece that is to remain, whereby the cutting mold can be moved toward the crackly plate-shaped work piece to cut off the crackly plate-shaped work piece along an edge of the holding mold set in alignment with the predetermined cutting line.

16. A cutting device for crackly plate-shaped work piece, which is used in the cutting method for crackly plate-shaped work piece as claimed in claim 1, the cutting device comprising a cutting mold movable toward the crackly plate-shaped work piece to cut off the crackly plate-shaped work piece along a predetermined cutting line, the cutting device being characterized in that the cutting device further comprises a holding mold including a movable holding mold and a fixed holding mold, the fixed holding mold being fixed on a press, the movable holding mold being drivable by a holding drive mechanism, whereby the movable holding mold and the fixed holding mold can tightly hold two opposite sides of the crackly plate-shaped work piece, both the movable holding mold and the fixed holding mold having holding edges in alignment with the predetermined cutting line of the crackly plate-shaped work piece.

17. A holding method for crackly plate-shaped work piece, a biting/cutting mold being used to bite and cut two faces of the crackly plate-shaped work piece to cut off the crackly plate-shaped work piece along predetermined cutting lines of the two faces of the crackly plate-shaped work piece, the holding method being characterized in that a holding mold set is used to hold two faces of the crackly plate-shaped work piece along the predetermined cutting line and hold a product section of the crackly plate-shaped work piece that is to remain, whereby the biting/cutting mold can bite and cut the two faces of the crackly plate-shaped work piece to cut off the crackly plate-shaped work piece along an edge of the holding mold set in alignment with the predetermined cutting line.

18. A cutting device for crackly plate-shaped work piece, which is used in the cutting method for crackly plate-shaped work piece as claimed in claim 1, the cutting device comprising a biting/cutting mold, which is used to bite and cut two faces of the crackly plate-shaped work piece to cut off the crackly plate-shaped work piece along predetermined cutting lines of the two faces of the crackly plate-shaped work piece, the cutting device being characterized in that the cutting device further comprises a holding mold set including a movable holding mold and a fixed holding mold, the fixed holding mold being fixed on a press, the movable holding mold being drivable by a holding drive mechanism, whereby the movable holding mold and the fixed holding mold can tightly hold two opposite sides of the crackly plate-shaped work piece and hole a product section of the crackly plate-shaped work piece that is to remain, whereby the biting/cutting mold can bite and cut the two faces of the crackly plate-shaped work piece to cut off the crackly plate-shaped work piece along an edge of the holding mold set in alignment with the predetermined cutting lines.
